(19) United States
(12) Patent Application Publication
(10) Pub. No.: US 2009/0245891 A1
(43) Pub. Date: Oct. 1, 2009

(54) ROLLING APPARATUS, DEVELOPMENT ROLLER AND METHOD FOR MANUFACTURING THE SAME, DEVELOPMENT DEVICE, AND IMAGE FORMING APPARATUS

(75) Inventors: Noboru SAKURAI, Chino (JP); Junichi Suzuki, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/137,736

(22) Filed: Jun. 12, 2008

(30) Foreign Application Priority Data
Jun. 19, 2007 (JP) 2007-161833

(51) Int. Cl. G03G 15/08

(52) U.S. Cl. 399/286

(57) ABSTRACT

An apparatus includes: a rolling die having protruding threads and a feeding unit moving the workpiece by L₁ per rotation. The rolling die includes: a straight portion maintaining a distance between a top of each protruded thread and an axial line of the rolling die nearly constant; and two tapered portions gradually reducing the distance outward from both ends of the straight portion. At least one tapered portion downstream of the workpiece has a width larger than L₁, and a distance r₁ between the top of each protruded thread and the axial line direction of the rolling die in the straight portion and a distance r₂ between the top of each protruded thread and the axial line direction of the rolling die at a portion separated from a boundary between the straight portion and the one tapered portion by L₁ satisfies the relation r₁−r₂≦5 micrometers.

### BACKGROUND

1. Technical Field

The present invention relates to a rolling apparatus, a development roller and a method for manufacturing the same, a development device, and an image forming apparatus.

2. Related Art

Image forming apparatuses employing an electro photographic method, such as printers, copiers, and facsimiles, form a toner image on recording mediums, such as paper, by a series of image forming processes including a charging step, an exposure step, a development step, a transfer step, a fixing step, and the like.

Such image forming apparatuses include a development device to visualize an electrostatic latent image on a photosensitive body as a toner image. The development device includes a development roller (developer carrier) carrying toners. The latent image on the photosensitive body is visualized with toners supplied by the development roller to the photosensitive body.

In general, the outer circumference surface of the development roller has finely roughened ridges and valleys for readily carrying toners.

As a method for forming such fine ridges and valleys, a blast treatment has been generally used. Alternatively, a rolling method has been proposed that form a fine ridges and valleys by pressing rolling die to a workpiece. The rolling method can form regular ridges and valleys unlike the blasting treatment. For example, refer to JP-A-2005-254202.

The rolling method disclosed in JP-A-2005-254202 performs rolling while the workpiece is fed in its axial direction relative to the rolling die, i.e., what is called through rolling. That is, the rolling die and the workpiece are mutually rotated and pressed in a condition in which the rolling die are disposed so as to slightly incline their axial lines with respect to the axial line of the workpiece when forming the ridges and valleys, in a manner disclosed in JP-A-2005-254202.

The rolling die used in the rolling method has a roller-like shape and a plurality of protruded threads on an outer circumference surface thereof, and the plurality of protruded threads extend in a direction inclined with respect to a circumferential direction of the rolling die in a parallel relationship with one another. The rolling die also includes a straight portion keeping a distance between the top of each protruded thread and the axial line of the rolling die constant (i.e., the outer diameter is constant), and a lead-in portion provided at one end side of the straight portion and a relief portion provided at the other end side of the straight portion.

Each of the lead-in and relief portions is tapered so that the distance between the top of each protruded thread and the axial line of the rolling die is gradually reduced outward. This shape helps the rolling die grip the workpiece well and the workpiece being stably fed.

The rolling method disclosed in JP-A-2005-254202, however, forms streaks along the circumferential direction of the workpiece every feeding pitch when the feeding amount of the workpiece becomes large, i.e., the tilt angle of die becomes large. Thus, the formed ridges and valleys vary in the depth of valleys and the height of ridges. As a result, using a development roller having such ridges and valleys causes grayscale variation.

### SUMMARY

An advantage of the invention is to provide a rolling apparatus that can manufacture a development roller having superior development characteristics while achieving low costs by improving productivity, a method for manufacturing the development roller, a development roller manufactured by the rolling apparatus or the manufacturing method, a development device and an image forming apparatus both of which having high reliability with the development roller.

The above advantage is attained by the following aspects of the invention.

According to a first aspect of the invention, a rolling apparatus includes: a rolling die having a roller-like shape and a plurality of protruded threads on an outer circumference surface thereof, the plurality of protruded threads extending in a direction inclined with respect to a circumferential direction of the rolling die in a parallel relationship with one another; and a feeding unit that disposes the rolling die so that an axial line of the rolling die is inclined with respect to an axial line of a workpiece having a hollow or solid cylindrical shape at a predetermined tilt angle, and rotates the rolling die around an axial line of the rolling die while pressing the rolling die to an outer circumference surface of the workpiece so as to move the workpiece relative to the rolling die in an axial line direction of the workpiece by a predetermined feeding amount L₁ corresponding to the predetermined tilt angle per one rotation of the workpiece. A groove is formed so as to incline with respect to an outer circumference direction of the workpiece with each of the protruded threads by pressing the outer circumference surface of the workpiece and the outer circumference surface of the rolling die. The rolling die includes: a straight portion at a central portion in the axial line direction thereof, the straight portion keeping a distance between a top of each of the protruded threads and the axial line of the rolling die nearly constant; and a pair of tapered portions each gradually reducing the distance outward from respective both ends of the straight portion. At least one of the pair of tapered portions, in a downstream side in a feeding direction of the workpiece, has a width in the axial line direction of the rolling die is larger than the predetermined feeding amount L₁, and a distance r₁ between the top of each of the protruded threads and the axial line direction of the rolling die in the straight portion and a distance r₂ between the top of each of the protruded threads and the axial line direction of the rolling die at a portion positioned apart from a boundary between the straight portion and at least one of the pair of tapered portion by the predetermined feeding amount L₁ satisfy a relation that r₁ minus r₂ is 5 micron meter or less.

Accordingly, an angulated portion is moderately formed in the vicinity of the boundary between at least one of the pair of tapered portions and the straight portion. The one tapered portion has the width capable of stably guiding the workpiece. Thus, a ridges and valleys can be formed on the outer circumference surface of the workpiece while streaks produced every feeding pitch of the workpiece due to the angulated portion are prevented from occurrence. As a result, the variation of the depth of ridges and the height of valleys in the formed ridges and valleys can be reduced. The development roller having superior development characteristics can be provided by being manufactured using the rolling apparatus. In addition, the occurrence of streaks every feeding pitch of the workpiece can be prevented even though the feeding amount of the workpiece becomes large, allowing the development roller having good quality as well as superior development characteristics to be provided while achieving low costs by improving productivity.

In the rolling apparatus, it is preferable that the width of each of the tapered portions be larger than the predetermined feeding amount L₁, and r₁ minus r₂ be 5 micron meter or less in each of the tapered portions.

The rolling apparatus can prevent streaks from occurrence while the protruded thread grips the workpiece well.

In the rolling apparatus, it is preferable that a radius r₃ of the workpiece satisfies a relation that r₁/r₃ be from 5 to 20.

Accordingly, the feeding amount L₁ of the workpiece can be increased while the workpiece is stably fed by suppressing the tilt angle of the rolling die. As a result, the development roller having good quality as well as superior development characteristics can be provided while achieving low costs by more steadily improving the productivity.

In the rolling apparatus, it is preferable that the predetermined tilt angle be from 0.1 to 5 degrees.

As a result, the development roller having superior development characteristics can be provided at low costs.

In the rolling apparatus, it is preferable that the predetermined feeding amount L₁ be from 0.1 to 5 mm.

As a result, the development roller having superior development characteristics can be provided at low costs.

In the rolling apparatus, it is preferable that the rolling die be disposed as one pair so as to sandwich and press the workpiece, and one rolling die form a plurality of first grooves and the other rolling die form a plurality of second grooves intersecting the plurality of first grooves.

Accordingly, ridges and valleys suitable for the development roller can readily and reliably be formed.

According to a second aspect of the invention, a method for manufacturing a development roller includes a step of preparing a workpiece that has a hollow or solid cylindrical shape and serves as an object of rolling; and a step of forming a groove for carrying a toner by pressing and relatively moving a rolling die in an axial line direction and on an outer circumference surface of the workpiece. The rolling die has a roller-like shape and a plurality of protruded threads on an outer circumference surface thereof, the plurality of protruded threads extending in a direction inclined with respect to a circumferential direction of the rolling die in a parallel relationship with one another. The rolling die includes: a straight portion at a central portion in an axial line direction thereof, the straight portion keeping a distance between a top of each of the protruded threads and the axial line of the rolling die; and a pair of tapered portions each reducing the distance outward from respective both ends of the straight portion. In the step of forming the groove, the rolling die is disposed so that an axial line of the rolling die is inclined with respect to an axial line of a workpiece having a hollow or solid cylindrical shape at a predetermined tilt angle, and rotated around the axial direction of the rolling die while being pressed to an outer circumference surface of the workpiece so as to move the workpiece relative to the rolling die in the axial direction of the workpiece by a predetermined feeding amount L₁ corresponding to the predetermined tilt angle per one rotation of the workpiece. At least one of the pair of tapered portions, in a downstream side in a feeding direction of the workpiece, has a width in the axial line direction of the rolling die is larger than the predetermined feeding amount L₁, and a distance r₁ between the top of each of the protruded threads and the axial line direction of the rolling die in the straight portion and a distance r₂ between the top of each of the protruded threads and the axial line direction of the rolling die at a portion positioned apart from a boundary between the straight portion and at least one of the pair of tapered portion by the predetermined feeding amount L₁ satisfy a relation that r₁ minus r₂ is 5 micron meter or less.

The method can provide a development roller having superior development characteristics.

According to a third aspect of the invention, a development roller is manufactured by the method for manufacturing a development roller of the second aspect. As a result, a development roller having superior development characteristics can be provided.

According to a fourth aspect of the invention, a development device includes the development roller of the third aspect. Accordingly, a development device having high reliability can be provided.

According to a fifth aspect of the invention, an image forming apparatus includes the development device of the fourth aspect. Accordingly, an image forming apparatus having high reliability can be provided.

### BRIEF DESCRIPTION OF THE DRAWINGS

The invention will be described with reference to the accompanying drawings, wherein like numbers reference like elements.

FIG. 1 is a schematic sectional view illustrating a schematic structure of an image forming apparatus according to an embodiment of the invention.

FIG. 2 is a schematic sectional view illustrating a schematic structure of a development device included in the image forming apparatus shown in FIG. 1.

FIG. 3 is a plan view illustrating a schematic structure of a development roller included in the development device shown in FIG. 2.

FIG. 4 is an enlarged plan view of a groove formed on the development roller shown in FIG. 3.

FIG. 5 is a sectional view taken along a line A-A in FIG. 4.

FIGS. 6A and 6B are views for explaining an example of steps of a method for manufacturing the development roller shown in FIG. 3.

FIG. 7 is a perspective view illustrating a schematic structure of a rolling apparatus forming a groove on an outer circumference surface of a workpiece in the manufacturing method shown in FIG. 5.

FIG. 8 is an enlarged side view of the rolling apparatus shown in FIG. 7.

FIG. 9 is a partially enlarged sectional view of a rolling die included in the rolling apparatus shown in FIG. 7.

FIG. 10 is a partially enlarged view for explaining an example of protruded threads of the rolling die shown in FIG. 9.

FIG. 11 is a partially enlarged view for explaining another example of protruded threads of the rolling die shown in FIG. 9.

### DESCRIPTION OF EXEMPLARY EMBODIMENTS

Embodiments of a rolling apparatus, a development roller and a method for manufacturing the same, a development device, and an image forming apparatus according to the invention will be described with reference to the accompanying drawings.

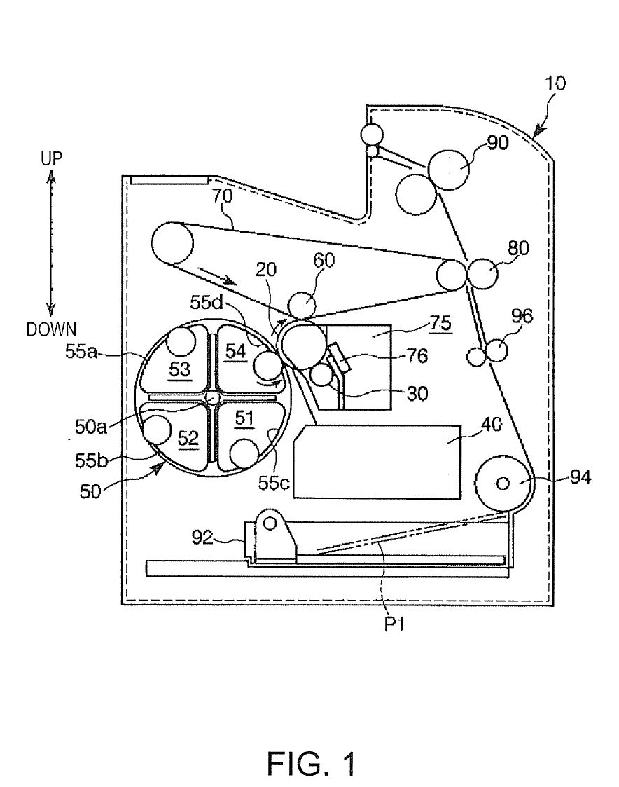

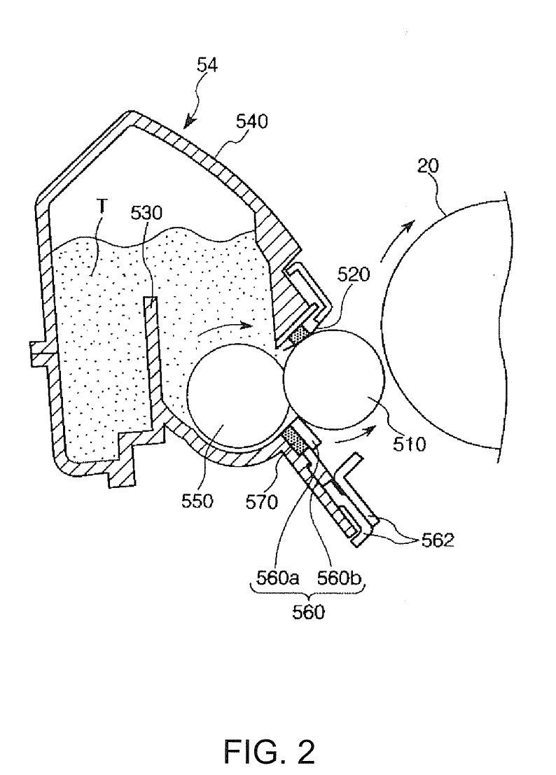

FIG. 1 is a schematic sectional view illustrating the schematic structure of an image forming apparatus according to an embodiment of the invention. FIG. 2 is a schematic sectional view illustrating the schematic structure of a development device included in the image forming apparatus shown in FIG. 1. In the following description, the top side in figures is described as “up”, while the bottom side is described as “down or lower.”

Image Forming Apparatus

With reference to FIG. 1, a laser beam printer (hereinafter, simply referred to as a printer) 10 is described as an example of the image forming apparatus.

As shown in FIG. 1, the printer 10 includes a photosensitive body 20 carrying a latent image and rotating in the arrow direction in the figure. The printer 10 also includes a charging unit 30, an exposure unit 40, a development unit 50, a first transfer unit 60, an intermediate transfer body 70, and a cleaning unit 75 in this order along the rotational direction (in clockwise direction) of the photosensitive body 20. In addition, the printer 10 includes a paper feed tray 92, shown in the lower part of FIG. 1, feeding a recording medium P1 such as paper, a second transfer unit 80, and a fixing unit 90. The second transfer unit 80 and the fixing unit 90 are sequentially disposed in a direction along which the recording medium P1 is transferred downstream from the paper feed tray 90.

The photosensitive body 20 is composed of a hollow cylindrical conductive base and a photosensitive layer formed on the outer circumference surface of the conductive base. The photosensitive body 20 is rotatable around its axis in the direction of the arrow shown in FIG. 1 (in clockwise direction). The charging unit 30 uniformly charges the surface of the photosensitive body 20 by corona electrification.

The exposure unit 40 receives image information from a host computer (not shown), such as personal computer. Responding with the information, the exposure unit 40 irradiates the photosensitive body 20, uniformly charged, with a laser beam according to a desired pattern so as to carry (form) an electrostatic latent image on the outer circumference surface of the photosensitive body 20.

The development unit 50 includes four development devices: a black development device 51, a magenta development device 52, a cyan development device 53, and a yellow development device 54. By selectively using the development devices corresponding to a latent image on the photosensitive body 20, the development unit 50 visualizes the latent image on the photosensitive body as a toner image. The black development device 51 develops images using a black (K) toner. Likewise, a magenta (M) toner is used for the magenta development device 52, a cyan (C) toner for the cyan development device 53, and a yellow (Y) toner for the yellow development device 54.

The development unit 50 of the embodiment is rotatable to allow the development devices 51, 52, 53 and 54 to selectively face the photosensitive body 20 (in a predetermined order). Specifically, in the development unit 50, four holders 55a, 55b, 55c, and 55d hold the development devices 51, 52, 53, and 54 respectively. The holders 55a, 55b, 55c, and 55d are included in a holding body rotatable around an axis 50a. The holding body rotates to allow each of the development devices 51, 52, 53, and 54 to selectively face the photosensitive body 20 while keeping a relative positional relationship among the four devices. A detailed structure of each device will be described later.

The first transfer unit 60 transfers a toner image formed on the photosensitive body 20 to the intermediate transfer body 70.

The intermediate transfer body 70 is an endless belt and is driven to rotate (circulate) in the arrow direction shown in FIG. 1 at a circumferential velocity about the same as that of the photosensitive body 20. The intermediate transfer body 70 carries a toner image having at least one color of black, magenta, cyan, and yellow thereon. For example, toner images having the four colors including black, magenta, cyan, and yellow are sequentially transferred and layered to form a full color toner image when a full color image need to be formed.

The second transfer unit 80 transfers a toner image having single color or full colors formed on the intermediate transfer body 70 to the recording medium P1, such as paper, films, and cloth.

The fixing unit 90 heats and presses the recording medium P1 on which the toner image has been transferred so as to melt and fix the toner image on the recording medium P1 as a permanent image.

The cleaning unit 75 includes a cleaning blade 76 that is made of rubber and makes contact with the surface of the photosensitive body 20 between the first transfer unit 60 and the charging unit 30. The cleaning blade 76 scrapes off and removes toners remaining on the photosensitive body 20 after the toner image has been transferred on the intermediate transfer body 70 by the first transfer unit 60.

Next, the operation of the printer 10, which is structured as described above, will be described.

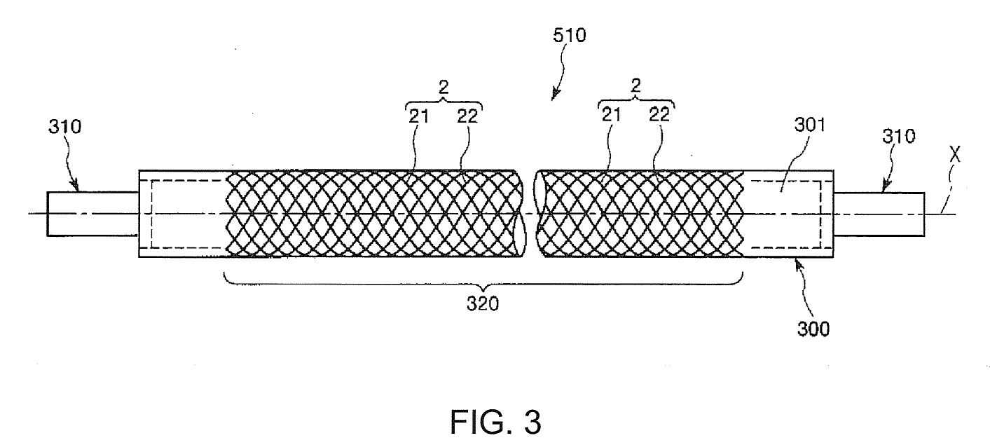

First, the photosensitive body 20, a development roller 510 and the intermediate transfer body 70 start rotation based on a command from a host computer (not shown). The development roller 510 is provided corresponding to each of the development devices 51, 52, 53, and 54 of the development unit 50, and will be described later with reference to FIGS. 2 and 3. The photosensitive body 20 is sequentially charged by the charging unit 30 while rotating.

A charged region on the photosensitive body 20 moves and reaches an exposure position facing the exposure unit 40 as the photosensitive body 20 rotates. At the position, a latent image corresponding to image information of the first color, e.g., yellow Y, is formed in the region by the exposure unit 40.

The latent image formed on the photosensitive body 20 moves and reaches a development position as the photosensitive body 20 rotates. At the position, the image is developed by the yellow development device with yellow toners. As a result, a yellow toner image is formed on the photosensitive body 20. At this time, the yellow development device 54 of the development unit 50 faces the photosensitive body 20 at the development position as shown in FIG. 1.

The yellow toner image formed on the photosensitive body 20 moves and reaches a first transfer position as the photosensitive body 20 rotates. At the position, the image is transferred to the intermediate transfer body 70 by the first transfer unit 60. Specifically, a first transfer voltage (a first transfer bias) having a polarity opposite to the charged polarity of toners is applied to the first transfer unit 60. By the first transfer voltage, the yellow toner image formed on the photosensitive body 20 is attracted and fixed on the intermediate transfer body 70. During this time, the second transfer unit 80 is kept apart from the intermediate transfer body 70.

By repeating the same process described above for the second color, the third color, and the fourth color, each color toner image corresponding to each image signal is transferred and layered on the intermediate transfer body 70. As a result, a full-color toner image is formed on the intermediate transfer body 70.

On the other hand, the recording medium P1 is transferred to the second transfer unit 80 from the paper feed tray 92 by a paper feed roller 94 and a registration roller 96.

The full-color toner image formed on the intermediate transfer body 70 moves and reaches a second transfer position at which the second transfer unit 80 is disposed as the intermediate transfer body 70 rotates. At the position, the image is transferred to the recording medium P1 by the second transfer unit 80. Specifically, a second transfer voltage (a second transfer bias) is applied to the second transfer unit 80, which is pressed to the intermediate transfer body 70. By the second transfer voltage, the full-color toner image formed on the intermediate transfer body 70 is attracted and transferred to the recording medium P1 interposed between the intermediate transfer body 70 and the second transfer unit 80.

The full-color toner image transferred to the recording medium P1 is heated and pressed by the fixing unit 90 so as to be melted and fixed on the recording medium P1. As a result, a fixed toner image is provided.

Here, after passing through the first transfer position, the photosensitive body 20 is cleaned by scrapping off and removing toners remaining on the surface with the cleaning blade 76 of the cleaning unit 75, being ready for being charged to form a subsequent latent image. The scrapped and removed toners are collected in a residue toner collection portion (not shown) inside the cleaning unit 75.

Development Device

Next, the development devices 51, 52, 53, and 54 of the development unit 50 will be described in detail. Since the development devices have about the same structure, the yellow development device 54 is representatively described below with reference to FIG. 2.

The yellow development device 54 shown in FIG. 2 includes a housing 540 containing a toner T (in this case, a yellow toner), the development roller 510 serving as a toner carrier, a toner supply roller 550 supplying the toner T to the development roller 510, and a restriction blade 560 restricting the layer thickness of the toner T carried on the development roller 510.

The housing 540 contains the toner T inside a containing portion 530 formed as its internal space. In the housing 540, the toner supply roller 550 and the development roller 510 are supported at and around an opening formed in a lower portion of the containing portion 530 so that they can rotate in a mutually pressure-contacted condition. The restriction blade 560 is attached to the housing 540 and pressure-contacted with the development roller 510. Also attached to the housing 540 is a seal member 520 to prevent the toner from being leaked from between the housing 540 and the development roller 510 at the opening.

The development roller 510 carries the toner T on its outer circumference surface and conveys the toner T to the photosensitive body 20 (i.e., to a development position in which the development roller 510 faces the photosensitive body 20. The development roller 510 is of a solid cylindrical shape and is rotatable around its axis. In the embodiment, the development roller 510 rotates in the opposite direction to the rotational direction of the photosensitive body 20.

In the embodiment, the development roller 510 and the photosensitive body 20 face each other in a non-contact condition with a minute gap left there between when a development is carried out by the yellow development device 54. By applying an alternating electric field to between the development roller 510 and the photosensitive body 20 (hereinafter, this condition is referred to as a “electric field applied condition”), the toner T is caused to fly from the development roller 510 to the photosensitive body 20, thereby developing a latent image on the photosensitive body 20.

The toner supply roller 550 supplies the toner T contained in the containing portion 530 to the development roller 510. The toner supply roller 550 is made of polyurethane foam or the like and is pressure-contacted with the development roller in an elastically deformed condition. In the embodiment, the toner supply roller 550 rotates in the opposite direction to the rotational direction of the development roller 510. The toner supply roller 550 not only functions to supply the toner T contained in the containing portion 530 to the development roller 510 but also scrape off the toner T remaining on the development roller 510 at the end of the development.

The restriction blade 560 restricts the layer thickness of the toner T carried on the development roller 510, and applies electric charges to the toner T carried on the development roller 510 by frictional charging in the restriction operation. The restriction blade 560 also serves as a seal member at an upstream side of the development position in the rotational direction of the development roller 510. The restriction blade 560 includes a rubber portion 560a serving as a contact member making contact with the development roller 510 along the axial direction thereof, and a rubber portion 560b serving as a support member supporting the rubber portion 560a. The rubber portion 560a is mainly made of silicon rubber, urethane rubber or the like. In view of the fact that the rubber support portion 560b functions to urge the rubber portion 560a toward the development roller 510, the rubber support portion 560b is formed of a sheet-like plate that has a spring property (elasticity), and made of metal, such as phosphor bronze and stainless steel. The rubber support portion 560b is fixed at its one end to a blade support metal plate 562. The blade support metal plate 562 and the seal member 520 are attached to the housing 540. Under the state in which the development roller 510 is mounted, the rubber portion 560a is pressed against the development roller 510 with an elastic force exerted by the rubber support portion 560b.

In this embodiment, a blade backing member 570 is provided on the opposite side of the restriction blade 560 from the development roller 510. The blade backing member 570 prevents the toner T from being infiltrated into between a rubber support portion 560b and the housing 540, and presses a rubber portion 560a against the development roller 510.

In the embodiment, the free end of the restriction blade 560, i.e., the end opposite to the side supported on a blade support metal plate 562 of the restriction blade 560, makes contact with the development roller 510 not at its distal edge but at the portion a little spaced apart from the distal edge. In addition, the restriction blade 560 is disposed so that its tip end faces the upstream side in the rotational direction of the development roller 510, thereby making what is called “counter-contact” with the development roller 510.

Here, the structure, function, and effect of each portion of the development device 51, 52, and 53 of the development unit 50 are the same as those of the development device 54.

Development Roller

With reference to FIGS. 3 to 5, the development roller 510 according to the invention will be described in detail.

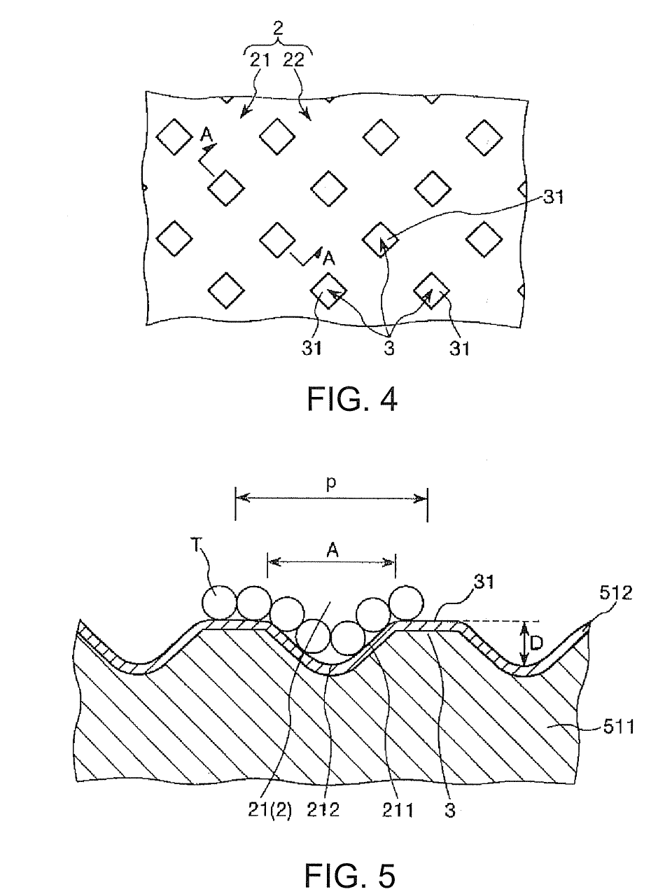

FIG. 3 is a plan view illustrating the schematic structure of the development roller included in the development device shown in FIG. 2. FIG. 4 is an enlarged plan view of grooves formed on the development roller shown in FIG. 3. FIG. 5 is a sectional view taken along the line A-A of FIG. 4.

As shown in FIG. 3, the development roller 510 includes a main body of a solid cylindrical shape, and a pair of reduced diameter portions 310, having a smaller diameter than that of the main body 300, protruding from the opposite ends of the main body 300 along the rotational axis (center axis) X of the main body 300.

The main body 300 is made of material mainly composed of metal, such as aluminum, stainless steel, and iron. The material used allows a groove 2 to be readily and reliably formed on an outer circumference surface 301 of the main body 300 by, for example, rolling (a rolling method). In addition, the toner T is carried on the outer circumference surface 301 of the main body 300 so as to be efficiently charged.

In the embodiment, the main body 300 is composed of a metal pipe 511 mainly made of a metal material, and a surface layer 512, such as a nickel plating and chromium plating, provided to cover the outer circumference surface of the metal pipe 511, as shown in FIG. 5. Here, the surface layer 512 may not be provided.

The diameter of the main body 300 is not limited, but it is preferable to be from 10 to 30 mm, more preferable to be from 15 to 20 mm.

As shown in FIG. 3, the groove 2 for carrying the toner T is formed on the outer circumference surface 301 of the main body 300. The groove 2 is structured of a plurality of first grooves 21 extending in generally parallel with one another, and a plurality of second grooves 22 extending in generally parallel with one another but intersecting the first grooves 21 (substantially orthogonally intersecting the first grooves 21 in the embodiment). That is, the plurality of first grooves 21 and the plurality of second grooves 22 are formed on the outer circumference surface 301 in a lattice pattern. As a result, a protrusion 3 is formed in a region enclosed by a pair of adjacent first grooves 21 and a pair of adjacent second grooves 22. The protrusion 3 has a top 31 having a flat surface.

As shown in FIG. 3, the first grooves 21 are formed along the outer circumference surface 301 in a spiral manner. In other words, the first grooves 21 extend in a direction inclined with respect to the circumferential direction of the outer circumference surface 301.

As shown in FIG. 5, each of the first grooves 21 is formed to have a section of a trapezoidal shape. The second grooves 22 have the same structure as that of the first grooves 21, except that they extend in the different direction from that of the first grooves 21 as described above. In FIG. 4, the first grooves 21 and the second grooves 22 are schematically shown for the sake of convenience in description.

Since the groove 2 is formed regularly and uniformly, a uniform and optimal quantity of the toner T can be carried on the development roller 510, and the tumbling capability (ease of tumbling movement) of the toner T on the outer circumference surface of the development roller 510 can be made uniform. As a result, it is possible to avoid local poor charging or poor conveyance of the toner, allowing the development roller to exhibit enhanced development characteristics.

Unlike one obtained by blasting, the groove 2 (ridges and valleys) exhibits excellent mechanical strength since the protrusion 3 of the groove 2 has the tip end of a relatively large width. Particularly, since the groove 2 is formed by rolling with rolling dies, which will be later described, the pressed portion has enhanced mechanical strength and resulting groove 2 shows greater mechanical strength than the one obtained by cutting work, for example. The development roller 510 having the groove 2 described as above can show increased durability even when it makes sliding contact with the restriction blade 560, the toner supply roller 550 and the like. Thus, the development roller 510 can be desirably employed in a development device that uses dry monocomponent nonmagnetic toners. In addition, the protrusion 3 undergoes little change in shape even when worn out since it has the top end (the top 31) of relatively large width as described above. This shape helps to prevent rapid degradation of development characteristics and makes it possible for the development roller to show excellent development characteristics for a prolonged period of time.

The width of each of the first grooves 21 and second grooves 22 is larger than the average particle diameter of the toner T. As a result, the toner T can be readily and reliably carried (held) by the groove 2 formed as described above.

Particularly, A/d is preferably from 2 to 20, and more preferably from 4 to 10, where A is the width (maximum width) of each of the first grooves 21 and second grooves 22, and d is the average particle diameter of the toner T (developer). As a result, the development roller 510 can carry the toner T (developer) in the groove 2 uniformly with an optimal amount thereof. If the value of A/d is less than the lower limit value, the following setbacks occur depending on the shape of the groove 2 or arrangement of the protrusion 3. The tumbling capability of the toner deteriorates due to insufficient supply of the toner into the groove 2, resulting in charging defects, or toner filming tends to occur due to excess amount of toner T accumulated in the groove 2. On the other hand, if the value of A/d is more than the upper limit value, the following setbacks occur depending on the shape of the groove 2 or arrangement of the protrusion 3. A carriage failure may occur due to insufficient amount of toner carried by the development roller 510, or the tumbling capability of the toner deteriorates due to a reduced chance of the toner making contact with the protrusion 3, which may result in charging defects.

In addition, D/d is preferably from 0.5 to 2, and more preferably from 0.9 to 1.3, where D is the depth of each of the first grooves 21 and second grooves 22, and d is the average particle diameter of the toner T (developer). As a result, the development roller 510 can carry the toner T in the groove 2 uniformly with an optimal amount thereof. If the value of D/d is less than the lower limit value, the tumbling capability of the toner T deteriorates because the toner is hardly caught by the protrusion 3 depending on the shape of the groove 2, tending to occur charging defects. On the other hand, if the value of D/d is more than the upper limit value, charging defects may occur since the toner in the groove 2 does not make contact with both the development roller 510 and the restriction blade 560 at all, depending on the shape of the groove 2.

The average particle diameter of the toner T preferably ranges from 1 to 10 μm, more preferably from 1 to 7 μm. Using the toner T having the average particle diameter described as above allows the toner T to be charged reliably and uniformly since the toner T smoothly tumbles on the outer circumference surface 301 without being accumulated in the groove 2.

Method for Manufacturing the Development Roller

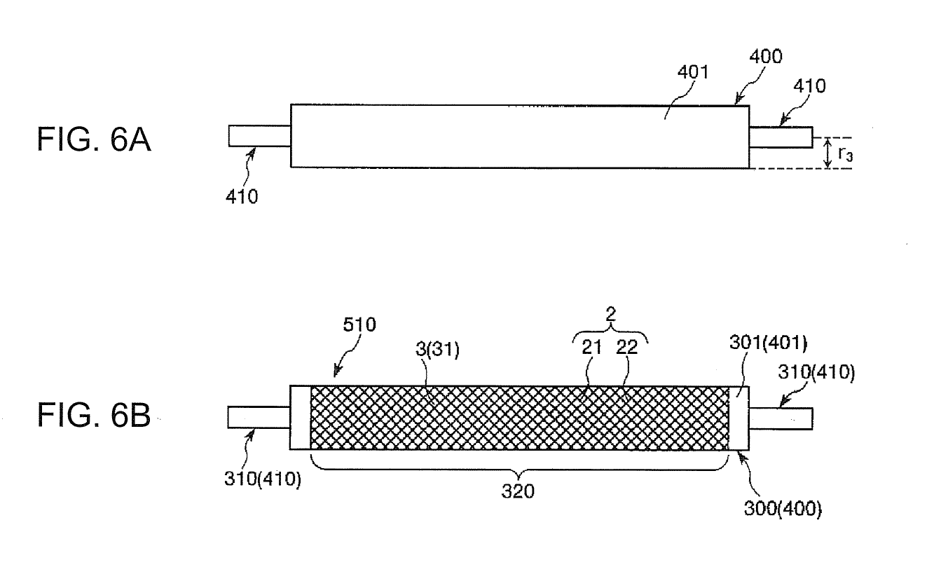

Next, a method for manufacturing the development roller 510 will be described with reference to FIGS. 6A to 11, as an example of a method for manufacturing a development roller according to the invention.

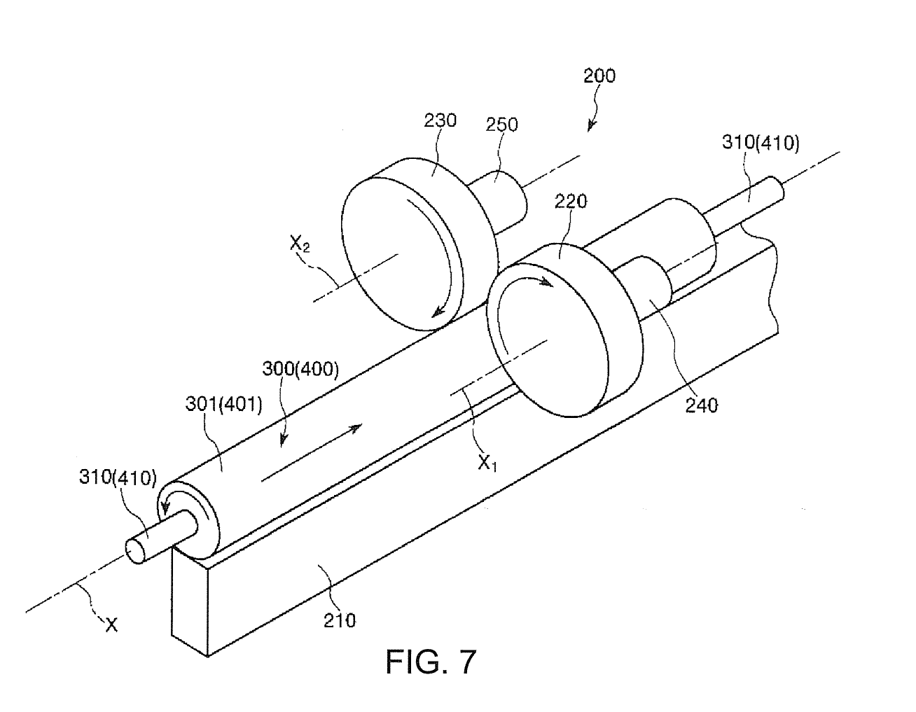

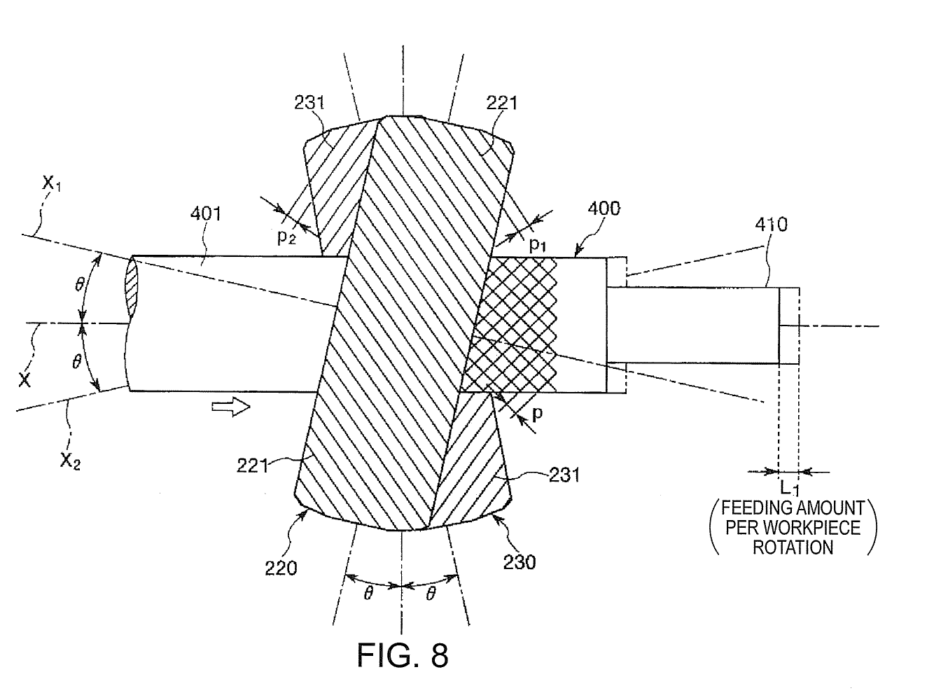

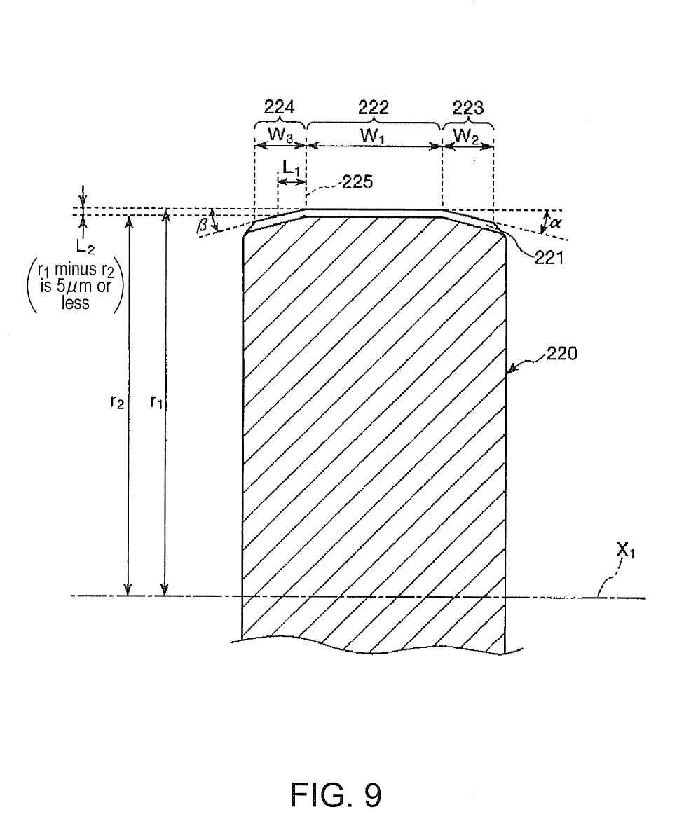

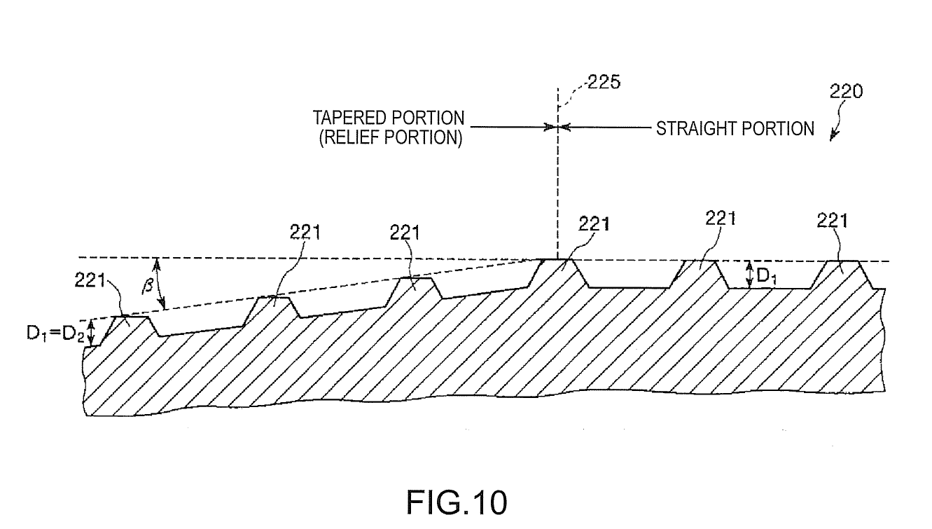

FIGS. 6A and 6B are views for explaining a method for manufacturing a development roller according to an embodiment of the invention. FIG. 7 is a perspective view illustrating the schematic structure of a rolling apparatus to form a groove on the outer circumference surface of a workpiece in the method shown in FIG. 5. FIG. 8 is an enlarged side view of the rolling apparatus shown in FIG. 7. FIG. 9 is a partially enlarged cross-sectional view of a rolling die included in the rolling apparatus shown in FIG. 7. FIG. 10 is a partially enlarged view illustrating an example of a protruded thread of the rolling die shown in FIG. 9.

The method for manufacturing the development roller 510 includes a step [1] of preparing a workpiece that is to become the development roller 510 and a step [2] of forming the groove 2 on the outer circumference surface of the workpiece.

Hereinafter, each of the steps will sequentially be explained in detail.

[1] Workpiece Preparing Step

As shown in FIG. 6A, a workpiece 400, which is to become the development roller 510, is prepared.

The workpiece 400 is to become the development roller 510, and includes a main body 401 of a solid cylindrical shape, and a pair of reduced diameter portions 410, which have a smaller diameter than that of the main body 401 and protrude from the opposite ends of the main body 401 along the center axis of the main body 401.

The outer circumference surface of the workpiece 400 is grinded by centerless grinding, for example, so that the axial line of the main body 401 of the workpiece 400 coincides with the axial line of the reduced diameter portions 410, if necessary.

[2] Groove Forming Step

As shown in FIG. 6B, the groove 2 is formed on the outer circumference surface of the main body 401 of the workpiece 400.

The process for forming the groove 2 will be described in detail with reference to FIGS. 7 to 10.

In forming the groove 2, a rolling apparatus 200 shown in FIG. 7 is used by way of example.

The rolling apparatus 200 shown in FIG. 7 performs rolling by a method what is called through-feed rolling (in-feed rolling). The rolling apparatus 200 includes a base 210 supporting the bottom side of the workpiece 400, and a first die 220 and a second die 230 (a pair of rolling dies) that press the opposite lateral sides of the workpiece 400 on the base 210.

The base 210 supports the workpiece 400 rotatably around an axial line X of the workpiece 400.

The pair of dies, the first rolling die 220 and the second rolling die 230 form the groove 2 for carrying toners, each of which is pressed to the outer circumference surface of the workpiece 400 subjected to rolling.

Each of the first rolling die 220 and the second rolling die 230 has a roller-like shape and is rotatable around own axial line.

The first rolling die 220 is supported in a state in which an axial line X₁ is slightly inclined with respect to the axial line X of the workpiece 400 by a feeding unit 240 fixedly provided to the base 210, and driven to rotate around the axial line X₁. Likewise, the second rolling die 230 is supported in a state in which an axial line X₂ is slightly inclined with respect to the axial line X of the workpiece 400 by a feeding unit 250 fixedly provided to the base 210, and driven to rotate around the axial line X₂.

The feeding units 240 and 250 are supported by a supporting unit (not shown) to the base 210 so as to maintain the axial lines X₁ and X₂ at a constant position and posture with respect to the axial line X.

Specifically, as shown in FIG. 7, the first rolling die 220 is disposed so that the axial line X₁ is inclined with respect to the axial line X of the workpiece 400 at a tilt angle θ. The first rolling die 220 is also rotatable around the axial line X₁.

In contrast, the second rolling die 230 is disposed so that the axial line X₂is inclined at the tilt angle θ with respect to the axial line X of the workpiece 400 in a side opposite to the side in which the axial line X₁ of the first rolling die 220 makes the tilt angle with respect to the axial line X. The second rolling die 230 is also rotatable around the axial line X₂.

The first rolling die 220 has a plurality of protruded threads (ridges) 221 for forming a plurality of first groove 21 as shown in FIG. 8. The plurality of protruded threads 221 extends in a direction inclined with respect to the circumferential direction of the die 220 in a parallel relationship with one another at a pitch p₁.

In contrast, the second rolling die 230 has a plurality of protruded threads (ridges) 231 for forming a plurality of second groove 22. The plurality of protruded threads 231 extends in a direction inclined with respect to the circumferential direction of the die 230 in a parallel relationship with one another at a pitch p₂.

The first rolling die 220 and the second rolling die 230 are pressed to the opposite lateral sides of the workpiece 400, and rotated in a direction opposite from one another. As a result, the workpiece 400 is processed by the first rolling die 220 and the second rolling die 230 while being fed into its axial line direction shown in FIG. 7 as the arrow.

In this processing, the workpiece 400 moves (is fed) in the axial line X direction relative to the first and second rolling dies 220 and 230 with a predetermined feeding amount L₁ per rotation of the workpiece 400. The feeding amount L₁ corresponds with and depends on the tilt angle θ.

Using the pair of rolling dies (the first rolling die 220 and the second rolling die 230) allows the groove 2 suitable for the development roller 510 to be formed readily and reliably as compared to forming the groove 2 using single rolling die.

That is, the first grooves 21 and the second grooves 22 are formed by using different rolling dies. The respective dies can be produced merely by forming a plurality of mutually parallel protruded threads, making it possible to simplify the shape of the dies and to readily form the groove 2.

The material of the first rolling die 220 and the second rolling die 230 is not particularly limited but may preferably be a material having a greater hardness than the workpiece 400. To be more specific, SKD, SKH, SLD or the like can be used for that purpose.

The pitch pi between the protruded threads 221 and the pitch p₂ between the protruded threads 231 are also not particularly limited but may preferably be in the range from 50 to 150 μm, and more preferably in the range from 50 to 100 μm. In the embodiment, the pitch p₂ is equal to the pitch p₁. The pitch p₁ and the pitch p₂ may differ from one another depending on the structure of the groove 2.

The first rolling die 220 will be described in detail, below. Since the second rolling die 230 has the same structure as that of the first rolling die 220, the description of the rolling die 220 will be omitted.

As described above, the first rolling die 220 has a roller-like shape and the protruded threads 221 on its outer circumference surface, and the protruded threads 221 extend in a direction inclined with respect to the circumferential direction of the rolling die 220 in a parallel relationship with one another.

As shown in FIG. 9, the first rolling die 220 includes a straight portion 222, and a pair of tapered portions 223 and 224. The straight portion 222 is formed at a central portion in the axial line X₁ direction so as to keep a distance between the top of the protruded threads 221 and the axial line X₁ nearly constant. The tapered portion 223 (a lead-in portion) and the tapered portion 224 (a relief-portion) are tapered so that the distance between the top of the protruded thread 221 and the axial line X₁ is gradually reduced outward from the both ends of the straight portion 222. Hereinafter, the distance between the top of the protruded thread 221 and the axial line X is also referred to as “radius.”

The tapered portion 223 serving as the lead-in portion is tapered so as to incline with respect to the straight portion 222 at a lead-in angle α while the tapered portion 224 serving as the relief portion is tapered so as to incline with respect to the straight portion 222 at a relief angle β. The angles α and β are not particularly limited as long as they can satisfy a condition of a step L₂ (i.e., a condition of r₁−r₂), which will be described later, but preferably from 0.05 to 1 degree, more preferably from 0.2 to 0.5 degrees. As a result, rolling can be stably performed even though the tilt angle θ fluctuates.

Each of the tapered portions 223 and 224 is structured so as to optimize the relationship between the feeding amount L₁ and thereof. The tapered portion 223 is described in relation to the feeding amount L₁, below. Since the tapered portion 224 has the same structure as that of the tapered portion 223, the description of the tapered portion 224 is omitted.

The tapered portion 224 satisfies the following relationships. A width W₃ is larger than the feeding amount L₁ in the axial line direction of the tapered portion 224 (i.e., in the axial line X₁ direction of the first rolling die 220), and r₁−₂ (the step L₂ shown in FIG. 9) is 5 μm or below. Here, r₁ is the distance (radius) between the top of each protruded thread 221 and the axial line X₁ in the straight portion 222, while r₂ is the distance (radius) between the top of each protruded thread 221 and the axial line X₁ at a portion positioned outward apart from a boundary 224, between the straight portion 222 and the tapered portion 224, by the feeding amount L₁.

This optimized relationship between the width W3 and the angle β of the tapered portion 224 allows the tapered portion 224 to have the width W₃ capable of stably guiding the workpiece 400 while an angulated portion is moderately formed in the vicinity of the boundary 225 between the tapered portion 224 and the straight portion 222.

This relationship also allows the groove 2 (the first grooves 21) to be formed on the outer circumference surface of the workpiece 400 while preventing streaks from being produced every feeding pitch of the workpiece 400 due to the angulated portion formed in the vicinity of the boundary 225 between the tapered portion 224 and the straight portion 222. As a result, the variation of the depth of the groove 2 and the height of the protrusion 3 can be reduced.

The development roller 510 having superior development characteristics can be provided by being manufactured using the rolling apparatus 200. In addition, the occurrence of streaks every feeding pitch of the workpiece 400 can be prevented even though the feeding amount L₁ of the workpiece 400 becomes large, allowing the development roller 510 having good quality as well as superior development characteristics to be provided while achieving low costs by improving the productivity. Further, the pair of tapered portions 223 and 224 reduces the width of the straight portion 222, making it possible to downsize the first rolling die 220 and the second rolling die 230. As a result, low costs can be achieved.

Particularly, in the relief portion, i.e., in the tapered portion 224 at a downstream side in the feeding direction of the workpiece 400, the width W₃ is larger than the feeding amount L₁, and r₁−r₂, i.e., the step L₂ is 5 μm or below. This structure can prevent the occurrence of streaks while the workpiece 400 is very stably fed. Notably, the optimized relationship between the width W₃ and the angle β of the tapered portion 224 serving as the relief portion can effectively prevent the occurrence of the streaks, showing remarkable effects of the invention.

In addition, in the lead-in portion, i.e., in the tapered portion 223 at an upstream side in the feeding direction of the workpiece 400, a width W₂ is larger than the feeding amount L₁, and r₁−r₂, i.e., the step L₂ is 5 μm or below. This structure can prevent the occurrence of streaks while the protruded thread 221 grips well the workpiece 400.

The step L₂ (i.e., r₁−r₂) is not particularly limited as long as it is more than zero and 5 μm or below, but preferably from 1 to 4.5 μm from the reason of manufacturing limit of dies or the like.

The radius r₁ of the straight portion 222 is equal to the maximum radius of the first rolling die 220, and not particularly limited, but preferably from 100 to 200 mm, more preferably from 120 to 180 mm.

In addition, r₁/r₃ is preferably from 5 to 20, more preferably from 7 to 15, where r₃ is the radius of the workpiece 400. Accordingly, the feeding amount L₁ of the workpiece 400 can be increased while the workpiece 400 is stably fed by suppressing the tilt angle θ of the first rolling die 220. As a result, the development roller 510 having good quality as well as superior development characteristics can be provided while achieving low costs by more steadily improving the productivity.

If the value of r₁/r₃ is less than the lower limit value, the dimensional accuracy of the groove 2 and the protrusion 3 may deteriorate or the first rolling die 220 may very rapidly wear off depending on the width of the first rolling die 220 in the axial line direction or the material of the workpiece 400. This is because the feeding amount L₁ becomes small, and the first groove 21 is formed by the protruded threads 221 with a small number of pressing. In contrast, if the value of r₁/r₃ is more than the upper limit value, resulting in a large size and high costs of the first rolling die 220.

The tilt angle θ of the axial line X₁ of the first rolling die 220 with respect to the axial line X of the workpiece 400 is preferably from 0.1 to 5 degrees, more preferably from 0.5 to 1.5 degrees. As a result, the development roller 510 having superior development characteristics can be provided at low costs.

If the tilt angle θ is less than the under limit value, the productivity may be lowered due to small feeding amount L₁ or the first rolling die 220 may become large and result in high costs. In contrast, the tilt angle θ more than the upper limit value may lower the feeding stability of the workpiece 400, which may result in deteriorating the dimensional accuracy of the groove 2 and the protrusion 3.

The feeding amount L₁ of the workpiece 400 with respect to the first rolling die 220 is preferably from 0.1 to 5 mm, more preferably from 0.5 to 1.5 mm. As a result, the development roller 510 having superior development characteristics can be provided at low costs.

The feeding amount L₁ less than the lower limit value lowers the productivity, resulting in high costs of the development roller 510. In contrast, the feeding amount L₁ more than the upper limit may become the first rolling die 220 large and result in high costs, or lower the feeding stability of the workpiece 400, which may result in deteriorating the dimensional accuracy of the groove 2 and the protrusion 3.

The width W₁ of the straight portion 222 is not particularly limited, but it is preferably from 0.5 to 50 mm, and more preferably from 4 to 30 mm.

The width W₂ of the tapered portion 223 is not particularly limited as long as it is larger than the feeding amount L₁ as described above, but it is preferably from 0.5 to 30 mm, more preferably from 1 to 5 mm.

The width W₃ of the tapered portion 224 is also not particularly limited as long as it is larger than the feeding amount L₁ as described above, but it is preferably from 0.5 to 30 mm, more preferably from 1 to 5 mm.

Here, the height of the protruded thread 221 in the straight portion 222 is defined as D₁ while the height of the protruded thread 221 in the tapered portion 224 is defined as D₂. The height D₁ may be equal to or different from the height D₂.

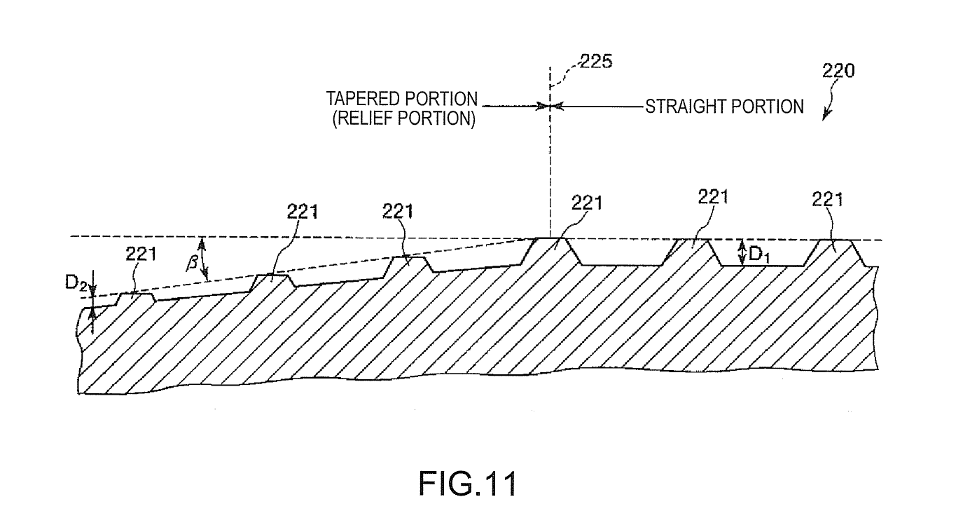

In addition, the height of the protruded thread 221 may gradually decreased outward from a side adjacent to the straight portion 222 as shown in FIG. 11 or may maintain nearly a constant height outward from a side adjacent to the straight portion 222 as shown in FIG. 10.

As described above, the rolling apparatus 200 can provide the development roller 510 having good quality as well as superior development characteristics with low costs by improving the productivity since the relationship between the width and slope of respective tapered portions 223 and 224 are optimized in relation to the feeding amount L₁.

After forming the groove 2 by using the rolling dies as described above, the surface is electro plated if necessary. This plating more increases the mechanical strength of the groove 2.

The electro plating is not particularly limited. Electroless Ni—P plating, electro plating, and hard chromium plating can be preferably used. The plating thickness is preferably from about 2 to 10 μm.

In a manner as described above, the development roller 510 can be manufactured.

The development roller 510 manufactured has superior development characteristics. In addition, the development unit (development device) 50 and the printer (image forming apparatus) 10 both of which include the development roller 510 have high reliability.

The rolling apparatus, the method for manufacturing a development roller, the development roller, the development device, and the image forming apparatus according to the invention have heretofore been described referring to the embodiments shown in the drawings. However, the invention is not limited to those embodiments and the components can be replaced with any ones having the same functions. In addition, any structures can be added.

In the aforementioned embodiments, the pair of tapered portions 223 and 224 is optimized in relation to the feeding amount L₁. However, either one of the tapered portions 223 and 224 may be optimized in relation to the feeding amount L₁.

In addition, the structure of the taper portion 223 may be equal to or different from that of the tapered portion 224.

### EXAMPLES

Specific examples of the invention will now be described.

1. Manufacturing Development Rollers

### Example 1

(1) A workpiece was prepared that was made of carbon steel tube for mechanical structure use and had a roller-like shape. The workpiece was used that has a solid cylindrical shape with a length of 314.5 mm and a diameter of 18 mm (radius r₃ is 9 mm) and includes a reduced diameter portions at its both ends.

(2) The grooves shown in FIGS. 4, 5, and 10 were formed on the outer circumference surface of the workpiece by a rolling method using the rolling apparatus shown in FIGS. 7 through 9.

The major conditions such as dimensions and the tilt angle of each rolling die of the rolling apparatus used are as follows.

Conditions of the rolling apparatus.
The outer diameter of the rolling die (=2 X r₁): 150 mm
The tilt angle θ of the rolling die: 0.5 degrees
The feeding amount L₁: 0.5 mm
The width W₁ of the straight portion: 10 mm
The width W₂ of the tapered portion (lead-in portion): 3 mm
The width W₃ of the tapered portion (relief portion): 3 mm
The angle α of the tapered portion (lead-in portion): 0.2 degrees
The angle β of the tapered portion (relief portion): 0.2 degrees
The step L₂(=r₁−r₂): 1.7 μm
The pitches p₁ and p₂ of the protruded threads: 80 μpm
The tilt angle with respect to the circumferential direction of each protruded thread: 45 degrees
The rotational speed of the rolling dies: 150 rpm

The major conditions such as dimensions and angles of each portion of the formed grooves are as follows.

Conditions of Each Portion of the Grooves
The depth of the first groove and the second groove: 5 μm
The intersecting angle of the first groove and the second groove: 90 degrees
The pitch p of the first groove and the second groove: 80 μm
The width A of the first groove and the second groove: 55 μm

(3) A surface layer was formed on the outer circumference surface of the steel tube by the following forming conditions.

Forming Conditions of the Surface Layer
The forming method: electroless plating
The composition: Ni—P (content rate of P: 10 wt %)
The average thickness: 5 μm

A development roller was manufactured by the above conditions.

### Examples 2 to 11

The development rollers were manufactured in the same manner as in the example 1 described above except the conditions of rolling dies shown in Table 1. In Table 1, in case where the step, width, and angle of the tapered portions are the same in the lead-in and relief portions, only one value is described in respective columns while in case of different values, the value of the lead-in portion is described in the left side and that of the relief portion is described in the left side in respective columns (Comparative Examples 1 to 8).

The development rollers were manufactured in the same manner as in the example 1 described above except the conditions of rolling dies shown in Table 1.

2. Evaluation

The surface of each development roller of examples and comparative examples was observed. Each development roller was built into a printer (LP-9000C manufactured by Seiko Epson Corporation) and an image of coverage rate of 50% was printed on recording sheet (high-quality paper, paper-J manufactured by Fuji Xerox, Co., Ltd.). Printed conditions were visually observed and surface conditions (occurrence of streaks) of the development rollers and printed conditions (occurrence of unevenness) were evaluated according to the following classifications. The evaluation results are shown in Table 1.

Here, a toner was used that is made of a polyester resin and has a sphere shape of an average particle diameter of 6.5 μm.

Surface Conditions of Development Roller
A: No streaks were observed
B: Streaks were slightly observed
C: Streaks were markedly observed

Printed Conditions
A: No unevenness was observed
B: Unevenness was slightly observed, causing no problem in practice
C: Unevenness was markedly observed

TABLE 1

| | Rolling Dies | | | | | | | | |
|---|---|---|---|---|---|---|---|---|---|
| | | | Tapered portion | | | | | | |
| | Straight portion | | (Lead-in portion Relief portion) | | | | | Workpiece | Evaluation |
| | 2r₃ | W₁ | L₂ | W₂ W₃ | a β | θ | L₁ | 2r₃ | Roller conditions/ |
| | [mm] | [mm] | [μm] | [mm] | [degree] | [degree] | [mm] | [mm] | Printed conditions |
| Example 1 | 150 | 10 | 1.7 | 3 | 0.2 | 0.5 | 0.5 | 18 | A/A |
| Example 2 | 150 | 10 | 2.2 | 3 | 0.25 | 0.5 | 0.5 | 18 | A/A |
| Example 3 | 150 | 10 | 2.9 | 3 | 0.33 | 0.5 | 0.5 | 18 | A/A |
| Example 4 | 150 | 10 | 4.4 | 3 | 0.5 | 0.5 | 0.5 | 18 | A/A |
| Example 5 | 150 | 10 | 2.6 | 3 | 0.2 | 0.75 | 0.75 | 18 | A/A |
| Example 6 | 150 | 10 | 3.3 | 3 | 0.25 | 0.75 | 0.75 | 18 | A/A |
| Example 7 | 150 | 10 | 4.3 | 3 | 0.33 | 0.75 | 0.75 | 18 | A/A |
| Example 8 | 150 | 10 | 3.5 | 3 | 0.2 | 1.0 | 1.0 | 18 | A/A |
| Example 9 | 150 | 10 | 4.4 | 3 | 0.25 | 1.0 | 1.0 | 18 | A/A |
| Example 10 | 150 | 10 | 4.4 | 3 | 0.2 | 1.25 | 1.25 | 18 | A/A |
| Example 11 | 150 | 10 | 6.5 2.6 | 3 | 0.5 0.2 | 0.75 | 0.75 | 18 | B/A |
| Comparative | 150 | 10 | 6.5 | 3 | 0.5 | 0.75 | 0.75 | 18 | C/C |
| Example 1 | | | | | | | | | |
| Comparative | 150 | 10 | 5.8 | 3 | 0.33 | 1.0 | 1.0 | 18 | C/C |
| Example 2 | | | | | | | | | |
| Comparative | 150 | 10 | 8.7 | 3 | 0.5 | 1.0 | 1.0 | 18 | C/C |
| Example 3 | | | | | | | | | |
| Comparative | 150 | 10 | 5.5 | 3 | 0.25 | 1.25 | 1.25 | 18 | C/C |
| Example 4 | | | | | | | | | |
| Comparative | 150 | 10 | 7.2 | 3 | 0.33 | 1.25 | 1.25 | 18 | C/C |
| Example 5 | | | | | | | | | |
| Comparative | 150 | 10 | 10.9 | 3 | 0.5 | 1.25 | 1.25 | 18 | C/C |
| Example 6 | | | | | | | | | |
| Comparative | 150 | 10 | 4.4 | 1 | 0.2 | 1.25 | 1.25 | 18 | C/C |
| Example 7 | | | | | | | | | |
| Comparative | 150 | 10 | 2.6 6.5 | 3 | 0.2 0.5 | 0.75 | 0.75 | 18 | C/C |
| Example 8 | | | | | | | | | |

As can been seen from Table 1, in each of the examples 1 to 11 of the invention, the streak of development roller was prevented from occurrence, and the printed condition was good. Particularly, in the examples 1 to 10, the surface conditions of development roller and printed conditions were extremely superior. The example 11 was superior to the comparative example 8 though it was slightly inferior to the examples 1 to 10 in evaluation results.

In contrast, the development roller of each comparison example was inferior to the examples 1 to 11 in the printed conditions due to the occurrence of streaks on its surface.

What is claimed is:

1. A rolling apparatus, comprising:
a rolling die having a roller-like shape and a plurality of protruded threads on an outer circumference surface thereof, the plurality of protruded threads extending in a direction inclined with respect to a circumferential direction of the rolling die in a parallel relationship with one another; and
a feeding unit that disposes the rolling die so that an axial line of the rolling die is inclined with respect to an axial line of a workpiece having a hollow or solid cylindrical shape at a predetermined tilt angle, and rotates the rolling die around an axial line of the rolling die while pressing the rolling die to an outer circumference surface of the workpiece so as to move the workpiece relative to the rolling die in an axial line direction of the workpiece by a predetermined feeding amount L₁ corresponding to the predetermined tilt angle per one rotation of the workpiece,
wherein a groove is formed so as to incline with respect to an outer circumference direction of the workpiece with each of the protruded threads by pressing the outer circumference surface of the workpiece and the outer circumference surface of the rolling die,
wherein the rolling die includes: a straight portion at a central portion in the axial line direction thereof, the straight portion keeping a distance between a top of each of the protruded threads and the axial line of the rolling die nearly constant; and a pair of tapered portions each gradually reducing the distance outward from respective both ends of the straight portion, and
wherein at least one of the pair of tapered portions, in a downstream side in a feeding direction of the workpiece, has a width in the axial line direction of the rolling die is larger than the predetermined feeding amount L₁, and a distance r₁ between the top of each of the protruded threads and the axial line direction of the rolling die in the straight portion and a distance r₂ between the top of each of the protruded threads and the axial line direction of the rolling die at a portion positioned apart from a boundary between the straight portion and at least one of the pair of tapered portion by the predetermined feeding amount L₁ satisfy a relation that r₁ minus r₂ is 5 micron meter or less.

2. The rolling apparatus according to claim 1, wherein the width of each of the tapered portions is larger than the predetermined feeding amount L₁, and r₁ minus r₂ is 5 micron meter or less in each of the tapered portions.

3. The rolling apparatus according to claim 1, wherein a radius r₃ of the workpiece satisfies a relation that r₁/r₃ is from 5 to 20.

4. The rolling apparatus according to claim 1, wherein the predetermined tilt angle is from 0.1 to 5 degrees.

5. The rolling apparatus according to claim 1, wherein the predetermined feeding amount L₁ is from 0.1 to 5 mm.

6. The rolling apparatus according to claim 1, wherein the rolling die is disposed as one pair so as to sandwich and press the workpiece, and one rolling die forms a plurality of first grooves and the other rolling die forms a plurality of second grooves intersecting the plurality of first grooves.

7. A method for manufacturing a development roller, comprising:
preparing a workpiece that has a hollow or solid cylindrical shape and serves as an object of rolling; and
forming a groove for carrying a toner by pressing and relatively moving a rolling die in an axial line direction and on an outer circumference surface of the workpiece,
wherein rolling die has a roller-like shape and a plurality of protruded threads on an outer circumference surface thereof, the plurality of protruded threads extending in a direction inclined with respect to a circumferential direction of the rolling die in a parallel relationship with one another,
wherein the rolling die includes: a straight portion at a central portion in an axial line direction thereof, the straight portion keeping a distance between a top of each of the protruded threads and the axial line of the rolling die; and a pair of tapered portions each reducing the distance outward from respective both ends of the straight portion,
wherein, in the step of forming the groove, the rolling die is disposed so that an axial line of the rolling die is inclined with respect to an axial line of a workpiece having a hollow or solid cylindrical shape at a predetermined tilt angle, and rotated around the axial direction of the rolling die while being pressed to an outer circumference surface of the workpiece so as to move the workpiece relative to the rolling die in the axial direction of the workpiece by a predetermined feeding amount L₁ corresponding to the predetermined tilt angle per one rotation of the workpiece,
wherein a groove is formed so as to incline with respect to an outer circumference direction of the workpiece with each of the protruded threads by pressing the outer circumference surface of the workpiece and the outer circumference surface of the rolling die, and
wherein at least one of the pair of tapered portions, in a downstream side in a feeding direction of the workpiece, has a width in the axial line direction of the rolling die is larger than the predetermined feeding amount L₁, and a distance r₁ between the top of each of the protruded threads and the axial line direction of the rolling die in the straight portion and a distance r₂ between the top of each of the protruded threads and the axial line direction of the rolling die at a portion positioned apart from a boundary between the straight portion and at least one of the pair of tapered portion by the predetermined feeding amount L₁ satisfy a relation that r₁ minus r₂ is 5 micron meter or less.

8. A development roller manufactured by the method for manufacturing a development roller according to claim 7.

9. A development device, comprising the development roller according to claim 8.

10. An image forming apparatus, comprising the development device according to claim 9.
